(19) United States
(12) Patent Application Publication
(10) Pub. No.: US 2021/0210964 A1
(43) Pub. Date: Jul. 8, 2021

(54) PHOTOELECTRIC CONVERSION CIRCUIT, DRIVING METHOD THEREOF, PHOTOSENSITIVE DEVICE AND DISPLAY DEVICE

(71) Applicant: BOE TECHNOLOGY GROUP CO., LTD., Beijing (CN)

(72) Inventors: Xueyou CAO, Beijing (CN); Xiaoliang DING, Beijing (CN); Haisheng WANG, Beijing (CN); Yunke QIN, Beijing (CN); Pengpeng WANG, Beijing (CN); Bo CHEN, Beijing (CN); Ping ZHANG, Beijing (CN); Likai DENG, Beijing (CN); Wenjuan WANG, Beijing (CN)

(21) Appl. No.: 16/766,196

(22) PCT Filed: Dec. 18, 2019
(86) PCT No.: PCT/CN2019/126346

§ 371 Date: May 21, 2020

(30) Foreign Application Priority Data
Mar. 8, 2019 (CN) 201910176366.7

(51) Int. Cl. H02J 7/00; G06K 9/00

(52) U.S. Cl. CPC H02J 7/00045; H02J 2310/22; G06K 9/0004

(57) ABSTRACT

A photoelectric conversion circuit and a driving method thereof, a photosensitive device and a display device are disclosed. The photoelectric conversion circuit includes a photosensitive circuit, a detection circuit, and a charging circuit, and the photosensitive circuit is connected to the detection circuit and the charging circuit respectively. The photosensitive circuit is configured to convert an optical signal into an electric signal, output the electric signal to the detection circuit in a first state for detection of the optical signal and output the electric signal to the charging circuit in a second state for charging.

The application claims priority to Chinese patent application No. 201910176366.7, filed Mar. 8, 2019, the entire disclosure of which is incorporated herein by reference as part of the present application.

### TECHNICAL FIELD

The embodiments of the present disclosure are related to a photoelectric conversion circuit, a driving method thereof, a photosensitive device and a display device.

### BACKGROUND

With the continuous development of electronic technologies, electronic products, such as smart phones, wearable electronic devices, or the like, bring great convenience to people's lives. A typical smart phone includes a processor, a memory, a display panel, a battery, and various functional modules. More and more functions are integrated in electronic products. For example, fingerprint identification functions have been widely applied to electronic payment, system unlocking and other applications.

### SUMMARY

At least an embodiment of the present disclosure provides a photoelectric conversion circuit, comprising a photosensitive circuit, a detection circuit and a charging circuit; the photosensitive circuit is connected to the detection circuit and the charging circuit respectively; and the photosensitive circuit is configured to convert an optical signal into an electric signal, and is configured to output the electric signal to the detection circuit in a first state for detection of the optical signal, and to output the electric signal to the charging circuit in a second state for charging.

In at least an example, the photosensitive circuit comprises a photosensitive element, a first control circuit, a storage circuit, and an output circuit; the photosensitive element is configured to receive the optical signal and convert the optical signal into the electric signal; the storage circuit is configured to store the electric signal; the output circuit is connected to the detection circuit and the charging circuit respectively; and the first control circuit is connected to the photosensitive element, the storage circuit, and the output circuit respectively, and is configured to output the electric signal to the output circuit in response to a first control signal.

In at least an example, the photosensitive element comprises a first terminal and a second terminal, the storage circuit comprises a first capacitor, and the first capacitor comprises a first electrode and a second electrode; the first electrode of the first capacitor is connected to the first terminal of the photosensitive element and is connected to a first node;

the second electrode of the first capacitor is connected to the second terminal of the photosensitive element and is connected to a second node; and the first control circuit is connected to the second node and the output circuit respectively, and is configured to input an electric signal of the second node to the output circuit in response to the first control signal.

In at least an example, the photosensitive element comprises a photodiode, and the first terminal and the second terminal of the photosensitive element are connected to an anode and a cathode of the photodiode respectively.

In at least an example, the photosensitive circuit further comprises a second control circuit, the second control circuit is connected to the first terminal of the photosensitive element and the first voltage terminal respectively, and is configured to apply a first voltage provided by the first voltage terminal to the first terminal of the photosensitive element in response to a second control signal.

In at least an example, the output circuit comprises an operational amplifier, and the operational amplifier comprises a first input terminal, a second input terminal, and an output terminal, the first input terminal is connected to a second voltage terminal to receive a second voltage, and the first voltage is lower than the second voltage, the second input terminal is connected to the first control circuit, and the output terminal is connected to the detection circuit and the charging circuit respectively.

In at least an example, the photosensitive circuit further comprises a third control circuit, the third control circuit is connected to the first input terminal of the operational amplifier and the first node respectively, and is configured to apply the second voltage to the first node in response to a third control signal.

In at least an example, the third control circuit comprises a third transistor, a first electrode of the third transistor is connected to the first node, a second electrode of the third transistor is connected to the first input terminal of the operational amplifier, and a gate of the third transistor is configured to receive the third control signal.

In at least an example, the photosensitive circuit further comprises a fourth control circuit and a fifth control circuit, the fourth control circuit is connected to the first node and the first electrode of the first capacitor respectively, the fifth control circuit is connected to the second node and the second electrode of the first capacitor respectively, and the fourth control circuit and the fifth control circuit are configured to control the connection of the first capacitor to the first node and the second node.

In at least an example, the photosensitive circuit further comprises a sixth control circuit and a seventh control circuit, the sixth control circuit is connected to the first terminal of the photosensitive element and the first node respectively, and the seventh control circuit is connected to the second terminal of the photosensitive element and the second node respectively.

In at least an example, the output circuit further comprises a second capacitor, and the second capacitor comprises a first capacitor electrode and a second capacitor electrode, the first capacitor electrode is connected to a second input terminal of the operational amplifier, and the second capacitor electrode is connected to an output end of the operational amplifier.

In at least an example, a capacitance of the first capacitor is at least 10 times as large as a capacitance of the second capacitor.

In at least an example, the first control circuit comprises a first transistor, a first electrode of the first transistor is connected to the second node, a second electrode of the first transistor is connected to the second input terminal of the operational amplifier, and a gate of the first transistor is configured to receive the first control signal.

In at least an example, the second control circuit comprises a second transistor, a first electrode of the second transistor is connected to the first terminal of the photosensitive element, a second electrode of the second transistor is connected to the first voltage terminal, and a gate of the second transistor is configured to receive the second control signal.

In at least an example, the photosensitive circuit comprises a photodiode, a first capacitor, an operational amplifier, a first transistor, a second transistor, and a third transistor, the operational amplifier comprises a first input terminal, a second input terminal and an output end, and the output end is connected to the detection circuit and the charging circuit respectively; the first capacitor comprises a first electrode and a second electrode; the first electrode of the first capacitor is connected to an anode of the photodiode and connected to a first node; the second electrode of the first capacitor is connected to a cathode of the photodiode and connected to a second node; a gate of the first transistor is configured to receive a first control signal, and a first electrode and a second electrode of the first transistor are connected to the second node and the second input terminal of the operational amplifier respectively; a gate of the second transistor is configured to receive a second control signal, and a first electrode and a second electrode of the second transistor are connected to the anode of the photodiode and a first voltage terminal respectively; the first input terminal of the operational amplifier is connected to a second voltage terminal to receive the second voltage, and the first voltage is lower than the second voltage; and a gate of the third transistor is configured to receive a third control signal, and a first electrode and a second electrode of the third transistor are connected to the first input terminal of the operational amplifier and the first node respectively.

In at least an example, the photosensitive circuit further comprises a fourth transistor and a fifth transistor, a gate of the fourth transistor is configured to receive a fourth control signal, and a first electrode and a second electrode of the fourth transistor are connected to the first node and the first electrode of the first capacitor respectively; and a gate of the fifth transistor is configured to receive a fifth control signal, and a first electrode and a second electrode of the fifth transistor are connected to the second node and the second electrode of the first capacitor respectively.

At least an embodiment of the present disclosure provides a photosensitive device, comprising any one of the above photoelectric conversion circuits.

In at least an example, the photosensitive device further comprises a fingerprint image acquisition device, the fingerprint image acquisition device is connected to the detection circuit; and the fingerprint image acquisition device is configured to receive the electric signal and is configured to acquire fingerprint image information according to the electric signal.

At least an embodiment of the present disclosure provides a display device, comprising any one of the above photoelectric conversion circuits any one of the above photosensitive devices.

At least an embodiment of the present disclosure provides a driving method for driving any one of the photoelectric conversion circuits, comprising: outputting the electric signal to the detection circuit in the first state to detect the optical signal, and outputting the electric signal to the charging circuit in the second state for charging.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a schematic diagram of a photoelectric conversion circuit according to some embodiments of the present disclosure;

FIG. 2 is a schematic diagram of a photoelectric conversion circuit according to some other embodiments of the present disclosure;

FIG. 3 is a schematic diagram of a photoelectric conversion circuit according to further embodiments of the present disclosure;

FIG. 4A is a schematic diagram of a photoelectric conversion circuit according to still further embodiments of the present disclosure;

FIG. 4B is a circuit diagram of a specific implementation example of the photoelectric conversion circuit shown in FIG. 4A;

FIGS. 5A-5C show schematic circuit diagrams and a corresponding signal timing diagram of the photoelectric conversion circuit when realizing a charging function;

FIGS. 6A-6C show schematic circuit diagrams and a corresponding signal timing diagram of the photoelectric conversion circuit when realizing the charging function;

FIGS. 7A-7B show a schematic circuit diagram and a corresponding signal timing diagram of the photoelectric conversion circuit when realizing an optical detection function;

FIGS. 8A-8B show another schematic circuit diagram and a corresponding signal timing diagram of the photoelectric conversion circuit when realizing the optical detection function;

FIG. 9A is a schematic diagram of a photoelectric conversion circuit according to some embodiments of the present disclosure;

FIG. 9B is a circuit diagram of a specific implementation example of the photoelectric conversion circuit shown in FIG. 9A;

FIG. 10A is a schematic diagram of a photoelectric conversion circuit according to some other embodiments of the present disclosure;

FIG. 10B is a circuit diagram of a specific implementation example of the photoelectric conversion circuit shown in FIG. 10A;

FIG. 11 is a schematic diagram of a photosensitive device according to some embodiments of the present disclosure;

FIG. 12 is a schematic diagram of a display device according to some embodiments of the present disclosure; and

FIG. 13 is a schematic structural diagram of a pixel unit in a display device according to some embodiments of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

As electronic apparatuses, such as smart phones, tablet computers, wearable electronic apparatuses, or the like, can realize more and more functions, a growing number of functional modules are integrated into the electronic apparatus, and power consumption is increasingly large, thereby shortening the life span of the electronic apparatuses and degrading user experience. In addition, simply increasing battery capacity may make the electronic apparatus bulky, unable to meet the needs of people.

At least one embodiment of the present disclosure provides a photoelectric conversion circuit, which can not only generate and provide a photoelectric signal for detection to realize a specific function (such as fingerprint identification, touch detection, or the like), but also generate and utilize the photoelectric signal to charge a charging circuit, thereby providing power reserves for a device. For example, when the photoelectric conversion circuit is not required to perform optical detection to realize the related functions, ambient light may be sensed for a long time and converted into an electric signal, and the electric signal can be used for charging a rechargeable battery, which improves integration of the apparatus while prolonging the life span of the device.

It should be noted that the transistor utilized in all of the embodiments of the present disclosure may be a thin film transistor, a field effect transistor or other switching devices with the same characteristics. In the embodiments of the present disclosure, descriptions are made using the thin film transistor as an example. Since the source and drain of a transistor utilized herein may be symmetrical, the source and drain of it are exchangeable structurally. In the embodiments of the present disclosure, in order to distinguish the two electrodes of the transistor except the gate, one of the electrodes is referred to as a first electrode and the other one of the electrodes is referred to as a second electrode.

In the description of each embodiment of the present disclosure, a first node, a second node, or the like do not necessarily represent subsistent components, but may represent a junction of related circuit connections in a circuit diagram.

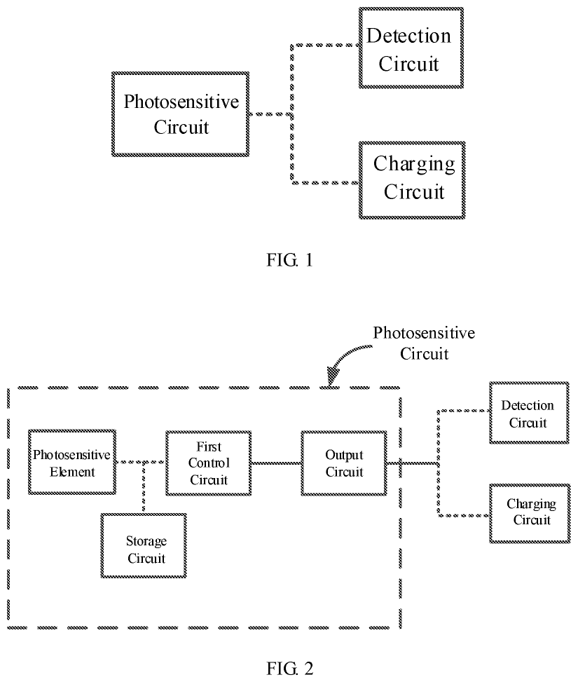

FIG. 1 is a schematic diagram of a photoelectric conversion circuit according to some embodiments of the present disclosure. As shown in FIG. 1, the photoelectric conversion circuit includes a photosensitive circuit, a detection circuit, and a charging circuit, and the photosensitive circuit is connected to the detection circuit and the charging circuit respectively. The photosensitive circuit is configured to convert an optical signal into an electric signal, output the electric signal to the detection circuit in a first state for detection of the optical signal and output the electric signal to the charging circuit in a second state for charging.

For example, the photosensitive circuit may be directly connected to the detection circuit and the charging circuit respectively, or indirectly connected through other elements (as shown by the dashed line in FIG. 1), which is not limited in the embodiments of the present disclosure.

For example, the photosensitive circuit includes a photosensitive element which can receive an optical signal and convert the optical signal into an electric signal. For example, the photosensitive element may include a first electrode, a second electrode, and a photosensitive layer interposed between the first and second electrodes.

For example, the photosensitive element may be implemented as a photodiode, such as a PN or PIN photodiode, an avalanche photodiode, or the like. The photosensitive layer includes, for example, a PN junction or a PIN junction. For example, the photosensitive layer may be made of an inorganic photosensitive material, such as a germanium-based or silicon-based material; for example, the photosensitive layer may also be made of an organic photosensitive material.

For example, the photosensitive element may also be implemented as a metal-semiconductor-metal photosensitive element, and the photosensitive layer forms schottky contact with the first and second electrodes respectively. For example, the photosensitive layer includes at least one of indium gallium arsenide (InGaAs), amorphous silicon, molybdenum sulfide, indium gallium zinc oxide, polycrystalline silicon, amorphous selenium, mercury iodide, lead oxide, microcrystalline silicon, nanocrystalline silicon, monocrystalline silicon, perylene tetracarboxylic acid bisbenzimidazole, silicon nanowires, and copper phthalocyanine (CuPc).

For example, the photosensitive element may also be implemented as other types of photosensitive elements, such as a photosensitive thin film transistor. The type of the photosensitive element is not limited in the embodiments of the present disclosure.

For example, the detection circuit may be a fingerprint detection circuit or a touch detection circuit, for example, including a sampling circuit, an amplification circuit, an analog-to-digital conversion circuit, or the like. For example, an input terminal of the detection circuit is directly connected to the photosensitive circuit or indirectly connected thereto through, for example, a switching element, and an output terminal of the detection circuit is connected to a processor (e.g., a central processing unit (CPU) or a digital signal processor (DSP), etc.). The detection circuit performs further amplification, analog/digital conversion, etc. on the received electric signal to obtain a digital signal, and transmits the digital signal to the processor and implements a corresponding detection function.

Taking the detection circuit to realize fingerprint identification as an example, in the work process, the photosensitive circuit receives light reflected by a finger and converts the light into electric signals. For example, light with different intensities is reflected due to different reflectivities of fingerprint valleys (a concave surface with respect to a finger-operated surface (e.g., a glass surface)) and fingerprint ridges (a convex surface with respect to the finger-operated surface) of the finger to the light, thereby generating electric signals of different magnitudes. The detection circuit receives the electric signals and processes the same to obtain the corresponding digital signals, which are then transmitted to an image processor to obtain a fingerprint image of the finger surface further used for fingerprint identification.

The detection circuit may also be used to implement other photoelectric (signal) detection functions, such as touch detection, X-ray detection, or the like, which is not limited in the embodiments of the present disclosure.

For example, the charging circuit may include a voltage stabilizing circuit, an electrostatic protection circuit, and other sub-circuits, so as to convert the received electric signals into safe and stable electric energy. For example, an input terminal of the charging circuit is directly connected to the photosensitive circuit or indirectly connected thereto through, for example, a switching element, and an output terminal of the charging circuit is coupled to and charge a rechargeable battery (e.g., a secondary battery) or a storage capacitor, thereby providing power for an electronic apparatus. The type, parameters, or the like of the rechargeable battery are not limited in embodiments of the present disclosure, and the rechargeable battery may be, for example, a lithium ion battery, a nickel hydrogen battery, or the like.

For example, the photoelectric conversion circuit further includes a switch control circuit for inputting an electric signal output from the photosensitive circuit to the detection circuit or the charging circuit in response to a control signal to realize the detection function or the charging function. Switch control circuits may be integrated in the detection circuit and the charging circuit respectively, and may also be connected to the output circuit, the detection circuit and the charging circuit respectively. That is, the photosensitive circuit is connected to the detection circuit and the charging circuit through the switch control circuits respectively. Embodiments of the present disclosure do not specifically limit the implementation manner of the switch control circuit(s).

For example, the switch control circuit includes a dual-control switch, which, in response to the control signal, connects the photosensitive circuit to the detection circuit in a first state to detect the optical signal, and connects the photosensitive circuit to the charging circuit in a second state to charge the charging circuit.

In one example, as shown in FIG. 2, the photosensitive circuit further includes a first control circuit, a storage circuit, and an output circuit. The output circuit is directly or indirectly connected to the detection circuit and the charging circuit respectively. The first control circuit is connected to the photosensitive element, the storage circuit and the output circuit respectively, and the connection can be direct or through a switch element. The storage circuit is configured to store an electric signal generated by the photosensitive element, and the first control circuit is configured to output the electric signal to the output circuit in response to a first control signal.

By providing the first control circuit and the storage circuit, the electric signal generated by the photosensitive element can be controlled to be input into the storage circuit first for storage and accumulation, thereby obtaining a relatively large output signal, such as a relatively large output current, which not only facilitates signal reading, but also may have a relatively large charging current when the charging circuit is charged, saving and providing electric energy more effectively.

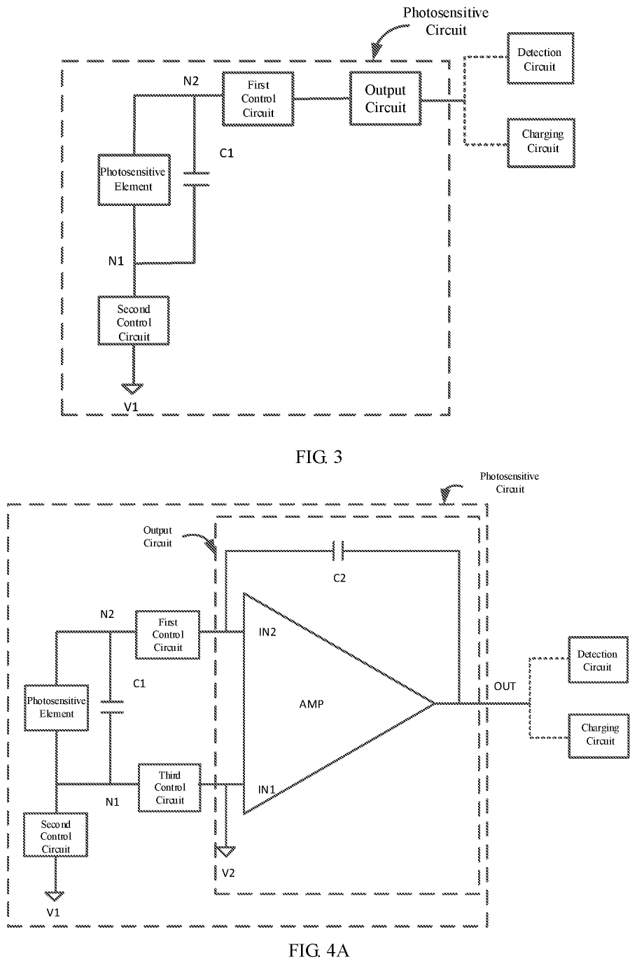

In one example, as shown in FIG. 3, the photosensitive element includes a first terminal and a second terminal, the storage circuit includes a first capacitor C1, and the first capacitor C1 includes a first electrode and a second electrode. The first electrode of the first capacitor C1 is connected to the first terminal of the photosensitive element and to a first node N1. The second electrode of the first capacitor is connected to the second terminal of the photosensitive element and to a second node N2. The first control circuit is connected to the second node N2 and the output circuit respectively, and is configured to input the electric signal of the second node into the output circuit in response to the first control signal.

For example, the first capacitor C1 has a capacitance in a range of 10 pF-100 pF.

For example, in the case where the photosensitive element is implemented as a photodiode, the first capacitor C has a size of 100 times or more the capacitance of the capacitor (reverse-bias capacitance) of the photodiode itself.

For example, when the photoelectric conversion circuit does not perform optical detection to realize related function, the photosensitive element can be used for sensing the ambient light for a long time and converting the ambient light into electric signals, and the storage circuit has a larger storage capacity to store photoelectric charges generated by photoelectric induction, such that effective storage and accumulation of the electric signal can be ensured.

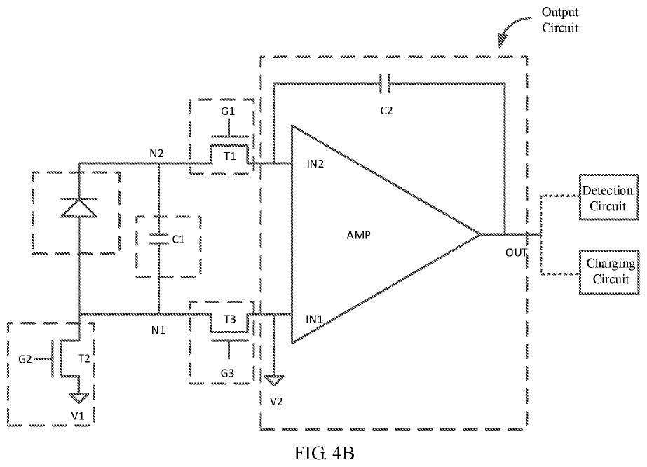

For example, as shown in FIG. 4A, the photosensitive circuit further includes a second control circuit, which is connected to the first terminal of the photosensitive element and a first voltage terminal respectively, and is configured to apply a first voltage V1 provided from the first voltage terminal to the first terminal of the photosensitive element in response to a second control signal.

For example, the output circuit includes an operational amplifier (AMP) including a first input terminal IN1 connected to a second voltage terminal to receive the second voltage V2, a second input terminal IN2 connected to the first control circuit, and an output terminal OUT connected to the detection circuit and the charging circuit respectively. For example, the first input terminal IN1 and the second input terminal IN2 are a non-inverting input terminal and an inverting input terminal of the operational amplifier respectively.

For example, the photosensitive circuit may further include a third control circuit connected to the first input terminal IN1 of the operational amplifier and the first node N1 respectively, and is configured to apply the second voltage V2 to the first node N1 in response to a third control signal.

For example, the photosensitive element includes a photodiode, and the first and second terminals of the photosensitive element are connected to an anode and a cathode of the photodiode respectively; the first voltage V1 is lower than the second voltage V2. The first voltage is, for example, from −2V to −6V, and the second voltage is from 0V to 5V, for example, a ground voltage.

Since the first and second input terminals IN1 and IN2 of the operational amplifier have a “virtual short” character, the voltage of the first input terminal IN1 is equal to the voltage of the second input terminal IN2, i.e., the second voltage V2.

As such, when the second control circuit controls the first voltage terminal to provide the first voltage V1 for the first terminal of the photosensitive element (i.e., the anode of the photodiode), and when the first control circuit controls the second input terminal IN2 of the operational amplifier to provide the second voltage V2 for the second terminal of the photosensitive element, the photodiode can be placed in a reverse-bias state.

In another case, the second control circuit disconnects the first terminal of the photosensitive element and the first voltage terminal, the third control circuit controls the second voltage terminal to provide the second voltage V2 for the first terminal of the photosensitive element, and the first control circuit controls the second input terminal IN2 of the operational amplifier to provide the second voltage V2 for the second terminal of the photosensitive element, such that the photodiode can be placed in a zero-bias state.

The zero-bias mode and the reverse-bias mode are two operating modes of the photodiode. For example, in the zero-bias mode, the photodiode has a relatively small dark current; in the reverse-bias mode, linear output may be implemented. The photoelectric conversion circuit according to some embodiments of the present disclosure can switch two operating modes of the photodiode, so as to select the operating mode according to actual needs. For example, when the photoelectric conversion circuit realizes the detection function, the reverse-bias mode of the photodiode may be selected to obtain the linear output character; when the photoelectric conversion circuit realizes the charging function, the zero-bias mode of the photodiode may be selected to have a relatively small dark current. However, the embodiments of the present disclosure are not limited to the above cases.

For example, the output circuit may further include a second capacitor C2, and the second capacitor C2 is connected between the second input terminal IN2 and the output terminal OUT of the operational amplifier. For example, the operational amplifier and the second capacitor C2 together constitute an integrator. The integrator can integrate a current signal to obtain a voltage signal, which facilitates the subsequent circuit reading and processing. As shown in FIG. 4A, the second capacitor C2 includes a first capacitor electrode connected to the second input terminal IN2 of the operational amplifier and a second capacitor electrode connected to the output terminal OUT of the operational amplifier.

For example, the second capacitor C2 has a capacitance in a range of 0.1 pF to 10 pF. For example, the first capacitor C1 is at least 10 times as large as the second capacitor C2.

FIG. 4B shows a specific structure of the photoelectric conversion circuit in FIG. 4A. For example, the first control circuit includes a first transistor T1, a first electrode of the first transistor T1 is connected to the second node N2, a second electrode of the first transistor T1 is connected to the second input IN2 of the output circuit, and a gate of the first transistor T1 is configured to receive the first control signal G1. The first transistor is turned on in response to the first control signal G1, thereby connecting the second input terminal IN2 with the second node N2 so as to supply the second voltage V2 to the second node N2.

For example, the second control circuit includes a second transistor T2, a first electrode of the second transistor T2 is connected to the first terminal of the photosensitive element, a second electrode of the second transistor is connected to the first voltage terminal, and a gate of the second transistor is configured to receive the second control signal G2. The second transistor is turned on in response to the second control signal G2, thereby connecting the first voltage terminal with the first terminal of the photosensitive element to provide the first voltage V1 for the first terminal of the photosensitive element.

For example, the third control circuit includes a third transistor T3, a first electrode of the third transistor is connected to the first node N1, a second electrode of the third transistor T3 is connected to the first input terminal IN1 of the operational amplifier, and a gate of the third transistor is configured to receive a third control signal G3. The third transistor is turned on in response to the third control signal G3, thereby connecting the second voltage terminal with the first node N1 so as to supply the second voltage V2 to the first node N1.

For example, the first transistor T1, the second transistor T2, and the third transistor T3 may be implemented as thin film transistors, active layers of which are, for example, amorphous silicon, polycrystalline silicon, or a metal oxide semiconductor, such as indium gallium zinc oxide (IGZO), aluminum-doped zinc oxide (AZO), indium zinc oxide (IZO), or the like.

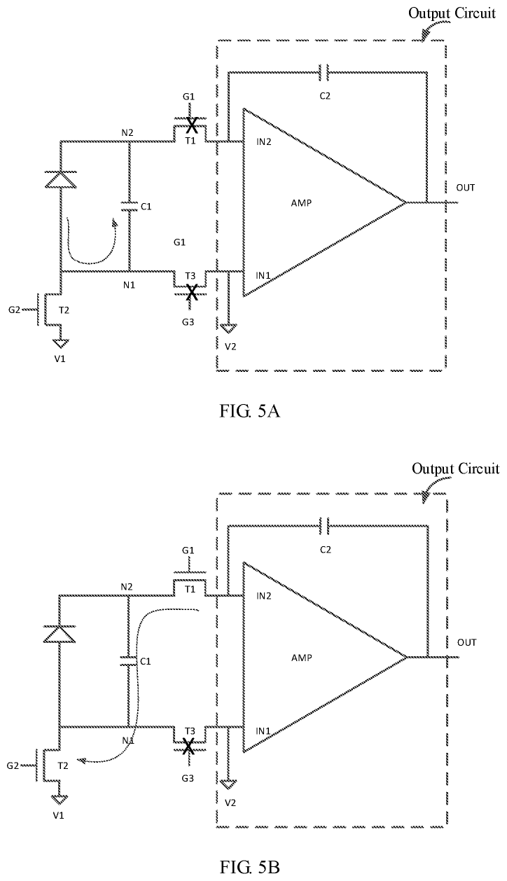

The operating principle of the photoelectric conversion circuit shown in FIG. 4B will be below exemplarily described with reference to FIGS. 5A to 5C, 6A to 6C, 7A to 7B, and 8A to 8B respectively.

FIGS. 5A-5C show schematic circuit diagrams and a corresponding signal timing diagram of the photoelectric conversion circuit when realizing the charging function. When the charging function is implemented, a work cycle of the photoelectric conversion circuit at least includes an energy storage stage 1 and a charging stage 2. FIGS. 5A and 5B show schematic circuit state diagrams of the photoelectric conversion circuit in the energy storage stage 1 and the charging stage 2 respectively. At this point, the photoelectric conversion circuit is in the second state, and the output circuit is connected to the charging circuit, which is omitted in FIGS. 5A-5B for clarity. FIG. 5C shows timing waveforms of the first to third control signals G1, G2, G3 in each stage. For example, each work cycle may further include a reset stage, which is not limited in the embodiments of the present disclosure.

In this example, the first, second and third transistors T1, T2, and T3 are all n-type transistors, and are turned on under the control of a higher turn-on voltage and turned off under the control of a lower turn-off voltage. However, the type of the transistor is not limited in the embodiments of the present disclosure. The following examples are the same and will not be repeated.

Referring to FIGS. 5A and 5C, in the energy storage stage 1, the first and third transistors T1 and T3 are turned off, the second transistor T2 is turned on, the first node N1 is connected to the first voltage terminal, and the first voltage V1 is used as a reference potential for charging the first capacitor C1. The photodiode receives an optical signal, converts the optical signal into an electric signal and stores the electric signal in the first capacitor C1. The arrow direction in FIG. 5A shows the current direction during the energy storage stage.

In the charging stage 2, the first and second transistors T1 and T2 are turned on, the third transistor T3 is turned off, the first node N1 is connected to the first voltage terminal, and the stored electric signal is output to the output circuit through the first transistor T1. The arrow direction in FIG. 5B shows the current direction during the charging stage.

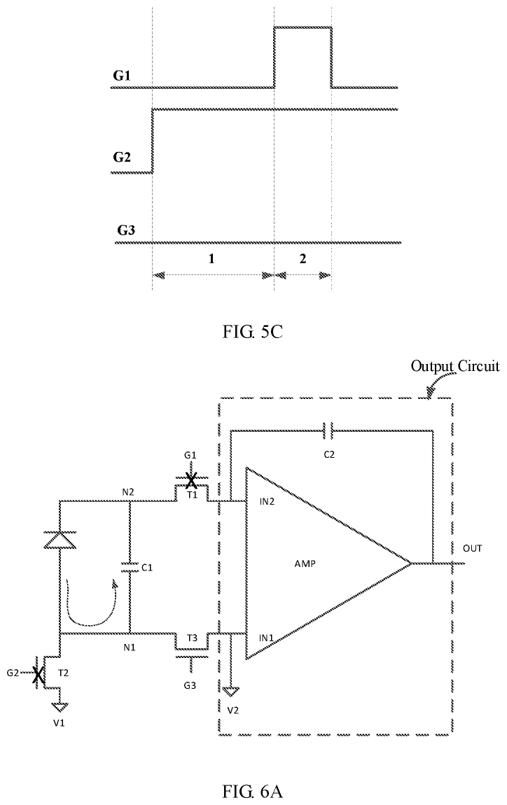

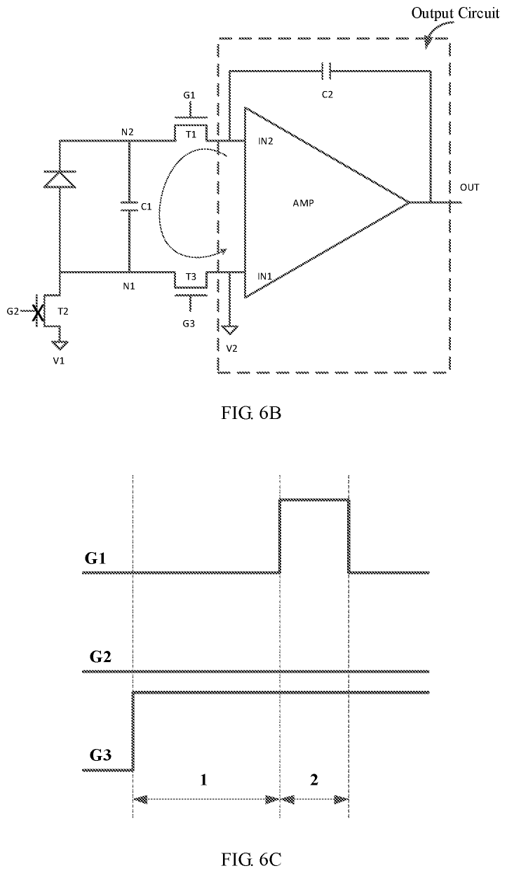

FIGS. 6A to 6C show another schematic circuit diagrams and a corresponding signal timing diagram of the photoelectric conversion circuit when realizing the charging function. FIGS. 6A and 6B show schematic circuit state diagrams of the photoelectric conversion circuit in the energy storage stage 1 and the charge stage 2 respectively, and FIG. 6C shows timing waveforms of the first to third control signals G1, G2, G3 in each stage. For example, each work cycle may further include a reset stage, which is not limited in the embodiments of the present disclosure.

In the energy storage stage 1, the first and second transistors T1 and T2 are both turned off, the third transistor T3 is turned on, the first node N1 is connected to the second voltage terminal, and the second voltage V2 is used as a reference potential for charging the first capacitor C1. The photodiode receives an optical signal, converts the optical signal into an electric signal and stores the electric signal in the first capacitor C1. The arrow direction in FIG. 6A shows the current direction during the energy storage stage.

In the charging stage 2, the first and third transistors T1 and T3 are turned on, the second transistor T2 is turned off, and the stored electric signal is output to the output circuit through the first transistor T1. The arrow direction in FIG. 6B shows the current direction during the charging stage.

Due to the provision of the first capacitor C1 with a larger capacitance, the electric signals generated by long-time photoreception of the photodiode can be stored effectively; because the discharge time of the charge is inversely proportional to a discharge current, by providing the first transistor T1, the charges stored in the first capacitor C1 can be controlled to be output within a short time period (e.g., several hundred microseconds to several hundred milliseconds) when the first transistor T1 is turned on, such that the output circuit outputs a large current to the charging circuit, and the electric energy can be stored more efficiently.

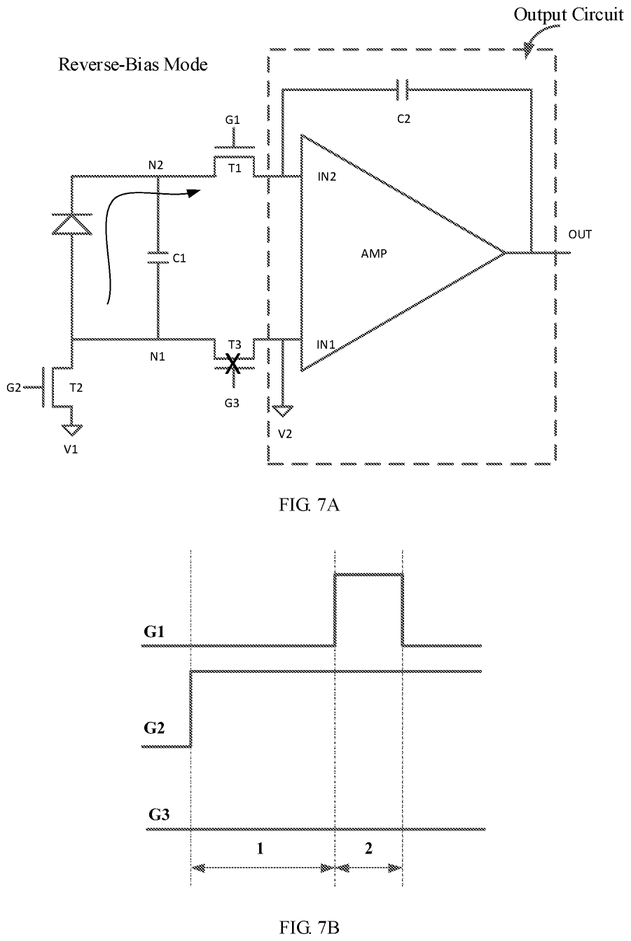

FIGS. 7A-7B show schematic circuit diagrams and a corresponding signal timing diagram of the photoelectric conversion circuit when realizing the optical detection function respectively. At this point, the photoelectric conversion circuit is in the first state and the output circuit is connected to the detection circuit, which is omitted in FIG. 7A for clarity.

Each work cycle at least includes a photosensing stage 1 and a reading stage 2, and FIG. 7B shows timing waveforms of the first to third control signals G1, G2, G3 in each stage. In another example, each work cycle may further include a reset stage, which is not limited in embodiments of the present disclosure.

As shown in FIGS. 7A and 7B, at this point, the third transistor T3 is normally turned off. When the first and second transistors T1 and T2 are turned on, the photodiode may be in the reverse-bias state.

In the photosensing stage 1, the first and third transistors T1 and T3 are both turned off, and the second transistor T2 is turned on, such that the first node is connected to the first voltage terminal. The photodiode receives the optical signal, converts the optical signal into an electric signal, and stores the electric signal in the first capacitor C1.

In the reading stage 2, the first and second transistors T1 and T2 are turned on, the third transistor T3 is turned off, the anode of the light emitting diode is connected to the first voltage terminal, and the cathode of the light emitting diode is connected to the second input terminal IN2 of the operational amplifier, such that the photodiode is in a reverse-bias state. The stored electric signal is output to the output circuit through the first transistor T1, and the arrow direction in FIG. 7A shows the direction of the output current during the reading stage.

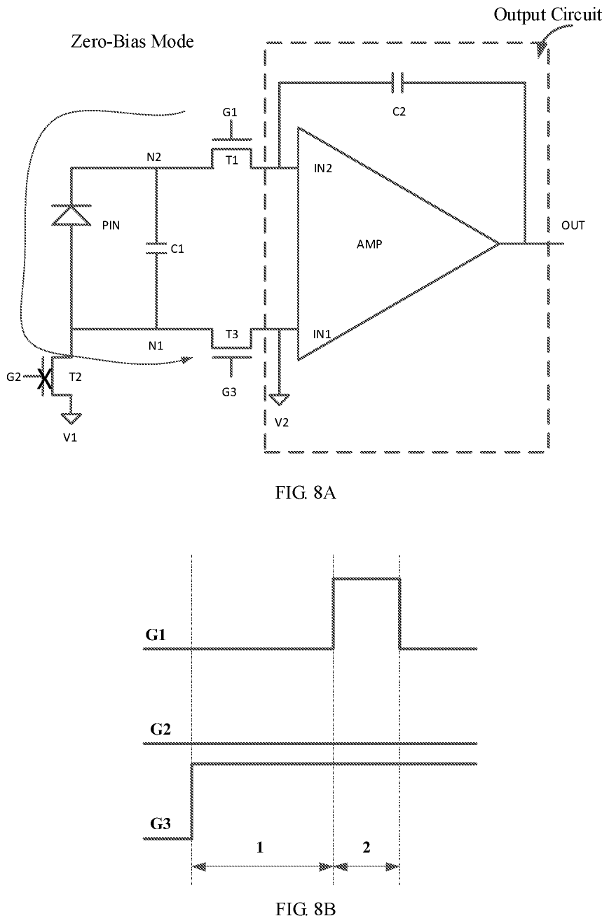

FIGS. 8A-8B show another schematic circuit diagrams and a corresponding signal timing diagram of the photoelectric conversion circuit when realizing the optical detection function respectively.

As shown in FIGS. 8A and 8B, at this point, the second transistor T2 is normally turned off. The photodiode can be placed in the zero-bias state when the first and third transistors T1 and T3 are turned on.

In the photosensing stage 1, the first and second transistors T1 and T2 are both turned off, and the third transistor T3 is turned on, such that the first node N1 is connected to the second voltage terminal. The photodiode receives the optical signal, converts the optical signal into an electric signal and stores the electric signal in the first capacitor C1.

In the reading stage 2, the second transistor T2 is turned off, the first and third transistors T1 and T3 are turned on, and the anode and the cathode of the light emitting diode are connected to the first and second input terminals IN1 and IN2 of the operational amplifier respectively, such that the photodiode is in a zero state. The stored electric signal of the light emitting diode is output to the output circuit through the first transistor T1. The arrow direction in FIG. 8A shows the direction of the output current during the reading stage.

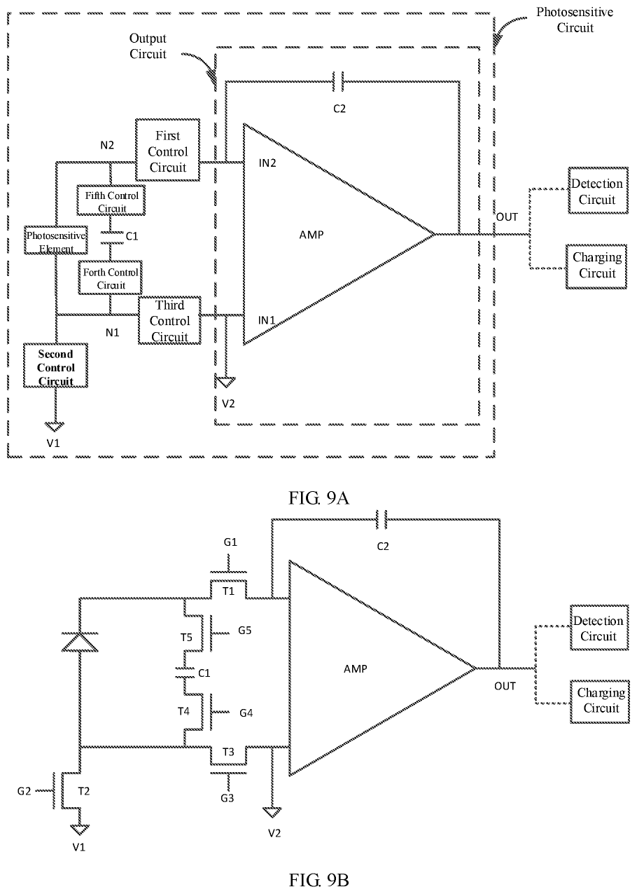

FIG. 9A is a schematic diagram of another photoelectric conversion circuit according to the embodiment of the present disclosure. As shown in FIG. 9A, the photosensitive circuit further includes a fourth control circuit connected to the first node N1 and the first electrode of the first capacitor C1 respectively, and includes a fifth control circuit connected to the second node N2 and the second electrode of the first capacitor C1 respectively. The fourth and fifth control circuits are configured to control the connection of the first capacitor C1 to the first node and the second node N1 and N2.

For example, as shown in FIG. 9B, the fourth control circuit includes a fourth transistor T4; of the fourth transistor T4, a first electrode is connected to the first node N1, a second electrode is connected to the first electrode of the first capacitor C1, and a gate is configured to receive a fourth control signal G4. The fourth transistor T4 connects the first electrode of the first capacitor C1 with the first node N1 in response to the fourth control signal G4.

For example, as shown in FIG. 9B, the fifth control circuit includes a fifth transistor T5; of the fifth transistor T5, a first electrode is connected to the second node N2, a second electrode is connected to the second electrode of the first capacitor C1, and a gate is configured to receive a fifth control signal G5. The fifth transistor T5 connects the second electrode of the first capacitor C1 with the second node N2 in response to the fifth control signal G5.

For example, when the photoelectric conversion circuit implements the optical detection function, for example, when the fingerprint identification function is implemented, because the touch by a finger is very short in time (several hundred milliseconds), the generated electric signal is relatively small. At this point, the electric signal can be stored only using the capacitor of the photodiode itself without using the first capacitor C1, and the first capacitor C1 and the first node and the second node N1 and N2 can be disconnected by the fourth and fifth control signals G4 and G5.

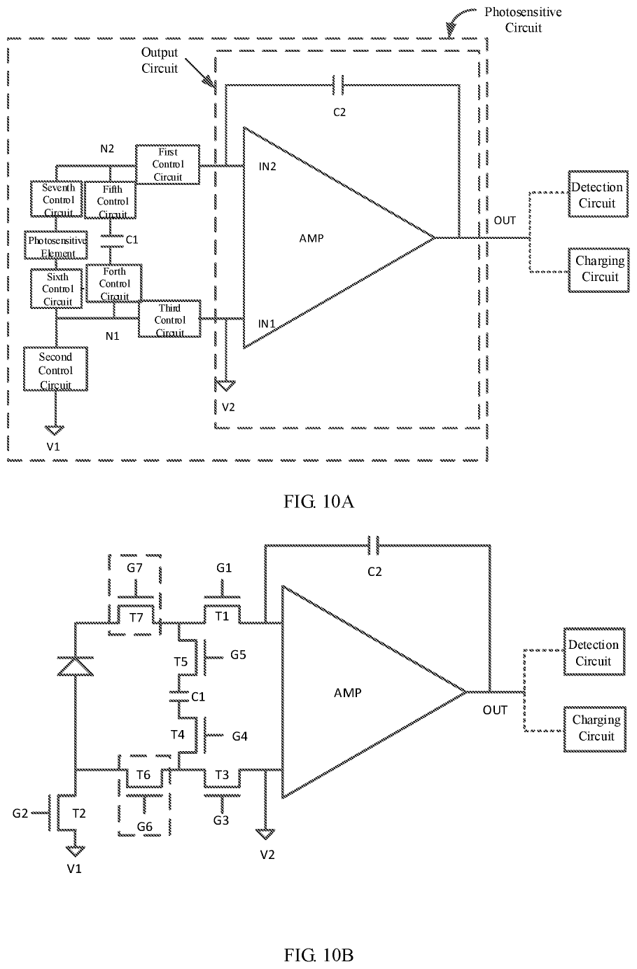

FIGS. 10A-10B are schematic diagrams of a photoelectric conversion circuit according to still another embodiment of the present disclosure. As shown in FIG. 10A, the photosensitive circuit further includes a sixth control circuit and a seventh control circuit, the sixth control circuit is connected to the first terminal of the photosensitive element and the first node N1 respectively, and the seventh control circuit is connected to the second terminal of the photosensitive element and the second node N2 respectively. The sixth and seventh control circuits are configured to control the connection of the photosensitive element to the first node and the second node N1 and N2.

For example, as shown in FIG. 10B, the sixth control circuit includes a sixth transistor T6; of the sixth transistor T6, a first electrode is connected to the first node N1, a second electrode is connected to the first terminal of the photosensitive element, and a gate is configured to receive a sixth control signal G6. The sixth transistor T6 connects the first terminal of the photosensitive element with the first node N1 in response to the sixth control signal G6.

For example, as shown in FIG. 10B, the seventh control circuit includes a seventh transistor T7; of the seventh transistor T7, a first electrode is connected to the second node N2, a second electrode is connected to the second terminal of the photosensitive element, and a gate is configured to receive a seventh control signal G7. The seventh transistor T7 connects the second terminal of the photosensitive element with the second node N2 in response to the seventh control signal G7.

For example, when the photoelectric conversion circuit implements the charging function, in the charging stage, in order to avoid the adverse effects on the discharge of the first capacitor C1 due to the continuous photoreception of the photosensitive element, the photosensitive element and the first node and the second node N1 and N2 can be disconnected by the sixth and seventh control signals G6 and G7.

For example, the fourth, fifth, sixth and seventh transistors T4, T5, T6, and T7 can be implemented as thin film transistors, active layers of which are, for example, amorphous silicon, polycrystalline silicon, or a metal oxide semiconductor (e.g., IGZO, AZO, IZO, etc.).

The above description is merely exemplary illustration of the photoelectric conversion circuit according to the embodiment of the present disclosure, and the work process of the photoelectric conversion circuit is not limited in the embodiment of the present disclosure.

Some embodiments of the present disclosure further provide a photosensitive device 20 including any of the above-mentioned photoelectric conversion circuits. As shown in FIG. 11, for example, the photosensitive device 20 further includes an image acquisition device connected to the detection circuit in the electrical conversion circuit, for example, and configured to receive the electric signal output by the detection circuit and to form fingerprint image information based on the electric signal for fingerprint identification.

For example, as shown in FIG. 11, the photosensitive device further includes a battery coupled to the charging circuit in the photoelectric conversion circuit to be charged by the charging circuit. The battery is used for providing power for the photosensitive device.

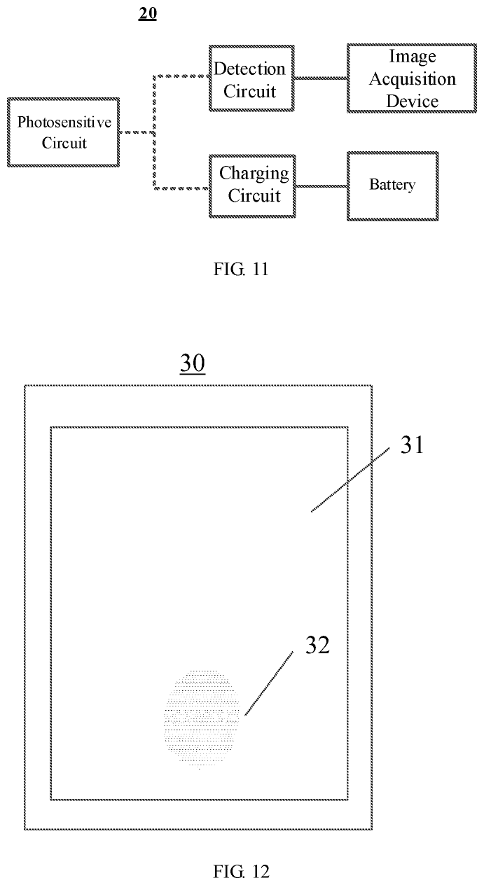

Some embodiments of the present disclosure further provide a display device including the above-mentioned photoelectric conversion circuit or the photosensitive device. FIG. 12 shows a schematic plan view of a display device 30 according to some embodiments of the present disclosure. As shown in FIG. 12, the display device 30 includes a display area 31, and a plurality of pixel units arranged in an array may be disposed in the display area 31, for providing a display operation. For example, the display area 31 may include a fingerprint identification area 32, and the above-mentioned photosensitive device 20 is disposed in the fingerprint identification area 32.

For example, in the fingerprint identification area 32 of the display area, each pixel unit is provided with one photosensitive device 20, and these photosensitive devices 20 themselves are also arranged in an array to form an image sensor to capture a fingerprint image.

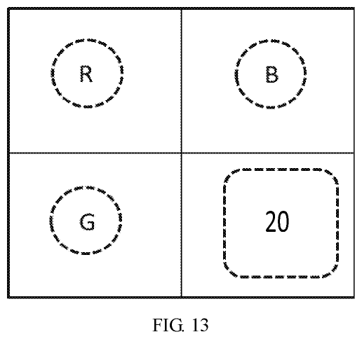

FIG. 13 shows a schematic structural diagram of a pixel unit according to an embodiment of the present disclosure. A pixel unit in the fingerprint identification area includes three sub-pixels RGB, which include light emitting elements emitting red light, green light, and blue light respectively, and the pixel unit is provided with one photosensitive device 20. The arrangements of the photosensitive devices and the sub-pixels are not limited in the embodiment of the present disclosure.

For example, the display device may be a liquid crystal display device, an organic light emitting diode display device, a quantum dot diode display device, an electronic paper display device, or the like.

Some embodiments of the present disclosure further provide a driving method for driving the photoelectric conversion circuit according to the embodiments of the present disclosure. The driving method includes: outputting the electric signal generated by the photosensitive circuit to the detection circuit in a first state to detect an optical signal, and outputting the electric signal to the charging circuit in a second state to charge. The specific process may refer to the foregoing description and is not described herein again.

The above described are only exemplary implementations of the present disclosure, and not intended to limit the protection scope of the present disclosure. The scope of the present disclosure is defined by the appended claims.

1. A photoelectric conversion circuit, comprising a photosensitive circuit, a detection circuit and a charging circuit, wherein
the photosensitive circuit is connected to the detection circuit and the charging circuit respectively; and
the photosensitive circuit is configured to convert an optical signal into an electric signal, and is configured to output the electric signal to the detection circuit in a first state for detection of the optical signal, and to output the electric signal to the charging circuit in a second state for charging.

2. The photoelectric conversion circuit according to claim 1, wherein
the photosensitive circuit comprises a photosensitive element, a first control circuit, a storage circuit, and an output circuit;
the photosensitive element is configured to receive the optical signal and convert the optical signal into the electric signal;
the storage circuit is configured to store the electric signal;
the output circuit is connected to the detection circuit and the charging circuit respectively; and
the first control circuit is connected to the photosensitive element, the storage circuit, and the output circuit respectively, and is configured to output the electric signal to the output circuit in response to a first control signal.

3. The photoelectric conversion circuit according to claim 2, wherein
the photosensitive element comprises a first terminal and a second terminal, the storage circuit comprises a first capacitor, and the first capacitor comprises a first electrode and a second electrode;
the first electrode of the first capacitor is connected to the first terminal of the photosensitive element and is connected to a first node;
the second electrode of the first capacitor is connected to the second terminal of the photosensitive element and is connected to a second node; and
the first control circuit is connected to the second node and the output circuit respectively, and is configured to input an electric signal of the second node to the output circuit in response to the first control signal.

4. The photoelectric conversion circuit according to claim 3, wherein the photosensitive element comprises a photodiode, and the first terminal and the second terminal of the photosensitive element are connected to an anode and a cathode of the photodiode respectively.

5. The photoelectric conversion circuit according to claim 3, wherein the photosensitive circuit further comprises a second control circuit,
the second control circuit is connected to the first terminal of the photosensitive element and the first voltage terminal respectively, and is configured to apply a first voltage provided by the first voltage terminal to the first terminal of the photosensitive element in response to a second control signal.

6. The photoelectric conversion circuit according to claim 5, wherein the output circuit comprises an operational amplifier, and the operational amplifier comprises a first input terminal, a second input terminal, and an output terminal,
the first input terminal is connected to a second voltage terminal to receive a second voltage, and the first voltage is lower than the second voltage,
the second input terminal is connected to the first control circuit, and
the output terminal is connected to the detection circuit and the charging circuit respectively.

7. The photoelectric conversion circuit according to claim 6, wherein the photosensitive circuit further comprises a third control circuit,
the third control circuit is connected to the first input terminal of the operational amplifier and the first node respectively, and is configured to apply the second voltage to the first node in response to a third control signal.

8. The photoelectric conversion circuit according to claim 7, wherein the third control circuit comprises a third transistor,
a first electrode of the third transistor is connected to the first node, a second electrode of the third transistor is connected to the first input terminal of the operational amplifier, and a gate of the third transistor is configured to receive the third control signal.

9. The photoelectric conversion circuit according to claim 2, wherein the photosensitive circuit further comprises a fourth control circuit and a fifth control circuit,
the fourth control circuit is connected to the first node and the first electrode of the first capacitor respectively,
the fifth control circuit is connected to the second node and the second electrode of the first capacitor respectively, and
the fourth control circuit and the fifth control circuit are configured to control the connection of the first capacitor to the first node and the second node.

10. The photoelectric conversion circuit according to claim 2, wherein the photosensitive circuit further comprises a sixth control circuit and a seventh control circuit,
the sixth control circuit is connected to the first terminal of the photosensitive element and the first node respectively, and
the seventh control circuit is connected to the second terminal of the photosensitive element and the second node respectively.

11. The photoelectric conversion circuit according to claim 5, wherein the output circuit further comprises a second capacitor, and the second capacitor comprises a first capacitor electrode and a second capacitor electrode,
the first capacitor electrode is connected to a second input terminal of the operational amplifier, and the second capacitor electrode is connected to an output end of the operational amplifier.

12. The photoelectric conversion circuit according to claim 11, wherein a capacitance of the first capacitor is at least 10 times as large as a capacitance of the second capacitor.

13. The photoelectric conversion circuit according to claim 6, wherein the first control circuit comprises a first transistor,
a first electrode of the first transistor is connected to the second node, a second electrode of the first transistor is connected to the second input terminal of the operational amplifier, and a gate of the first transistor is configured to receive the first control signal.

14. The photoelectric conversion circuit according to claim 5, wherein the second control circuit comprises a second transistor,
a first electrode of the second transistor is connected to the first terminal of the photosensitive element, a second electrode of the second transistor is connected to the first voltage terminal, and a gate of the second transistor is configured to receive the second control signal.

15. The photoelectric conversion circuit according to claim 1, wherein the photosensitive circuit comprises a photodiode, a first capacitor, an operational amplifier, a first transistor, a second transistor, and a third transistor;
the operational amplifier comprises a first input terminal, a second input terminal and an output end, and the output end is connected to the detection circuit and the charging circuit respectively;
the first capacitor comprises a first electrode and a second electrode;
the first electrode of the first capacitor is connected to an anode of the photodiode and connected to a first node;
the second electrode of the first capacitor is connected to a cathode of the photodiode and connected to a second node;
a gate of the first transistor is configured to receive a first control signal, and a first electrode and a second electrode of the first transistor are connected to the second node and the second input terminal of the operational amplifier respectively;
a gate of the second transistor is configured to receive a second control signal, a first electrode of the second transistor is connected to the anode of the photodiode, and a second electrode of the second transistor is connected to a first voltage terminal to receive a first voltage;
the first input terminal of the operational amplifier is connected to a second voltage terminal to receive the second voltage, and the first voltage is lower than the second voltage; and a gate of the third transistor is configured to receive a third control signal, and a first electrode and a second electrode of the third transistor are connected to the first input terminal of the operational amplifier and the first node respectively.

16. The photoelectric conversion circuit according to claim 15, wherein the photosensitive circuit further comprises a fourth transistor and a fifth transistor,
a gate of the fourth transistor is configured to receive a fourth control signal, and a first electrode and a second electrode of the fourth transistor are connected to the first node and the first electrode of the first capacitor respectively; and
a gate of the fifth transistor is configured to receive a fifth control signal, and a first electrode and a second electrode of the fifth transistor are connected to the second node and the second electrode of the first capacitor respectively.

17. A photosensitive device, comprising a photoelectric conversion circuit, which comprises a photosensitive circuit, a detection circuit and a charging circuit,
wherein the photosensitive circuit is connected to the detection circuit and the charging circuit respectively; and
the photosensitive circuit is configured to convert an optical signal into an electric signal, and is configured to output the electric signal to the detection circuit in a first state for detection of the optical signal, and to output the electric signal to the charging circuit in a second state for charging.

18. The photosensitive device according to claim 17, further comprising a fingerprint image acquisition device, wherein
the fingerprint image acquisition device is connected to the detection circuit; and
the fingerprint image acquisition device is configured to receive the electric signal and is configured to acquire fingerprint image information according to the electric signal.

19. A display device, comprising the photoelectric conversion circuit according to claim 1.

20. A driving method for driving the photoelectric conversion circuit according to claim 1, comprising:
outputting the electric signal to the detection circuit in the first state to detect the optical signal, and
outputting the electric signal to the charging circuit in the second state for charging.
